(19) United States
(12) Patent Application Publication
(10) Pub. No.: US 2006/0171880 A1
(43) Pub. Date: Aug. 3, 2006

(54) Compact steam reformer with metal monolith catalyst and method of producing hydrogen using the same

(76) Inventors: Heon Jung, Seo-gu (KR); Wang-Lai Yoon, Yuseong-gu (KR); Ho-Tae Lee, Yuseong-gu (KR); Jong-Soo Park, Seo-gu (KR); Jung-Il Yang, Yuseong-gu (KR); Jae-Hong Ryu, Jung-gu (KR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/322,363

(22) Filed: Jan. 3, 2006

(30) Foreign Application Priority Data
Dec. 31, 2004 (KR) KR 2004-118196

(51) Int. Cl. B01J 23/00; C01B 3/26

(52) U.S. Cl. 423/653; 502/335

(57) ABSTRACT

Disclosed herein is a catalyst structure for steam reformation, in which a nickel-based steam reforming catalyst is coated on a metal monolith. Also disclosed is a method for producing hydrogen using a steam reforming reaction, the method comprising bringing a mixed gas of steam and hydrocarbon into contact with the disclosed catalyst structure.

### BACKGROUND OF THE INVENTION

1. Field of the Invention

The present invention relates to a compact catalytic steam reformer for converting hydrocarbons, such as methane, neutral gas, liquefied petroleum gas (LPG), naphtha, volatile oil and diesel oil, into a mixture of hydrogen and carbon monoxide, by a steam reforming reaction, as well as a method for producing hydrogen using the same.

2. Background of the Invention

The steam reformer for supplying fuel hydrogen (or hydrogen mixture) to a small-sized fuel cell requires a compact design to reduce space and to obtain high thermal efficiency.

A steam reforming reaction is a typical endothermic reaction in which a large amount of reaction heat needs to be supplied. In this reaction, when reaction heat is effectively supplied to a catalyst, the reaction activity per unit of catalyst can increase to allow the size of a reactor to be reduced.

Generally, in a large-scale steam reforming process, a pellet-type catalyst is loaded into several tubular reactors, and reaction heat is supplied by high-temperature exhaust gas resulting from the combustion of fuel in the outside of the reactor tubes. In this case, the portion of exhaust gas supplied as reaction heat is only 50% (I. T. Horvath, Encyclopedia of Catalysis, vol. 4, p 11).

In an attempt to increase the supply ratio of reaction heat, a method of using a catalytic plate reactor in the steam reforming reaction is known. In the catalytic plate reactor, a catalytic combustion reaction section overlaps a steam reforming reaction section so as to increase a heat transfer area where reaction heat from high-temperature gas generated by catalytic combustion is transferred to a steam reforming catalyst in the adjacent section. The catalyst is disposed between plates in a pellet form (U.S. Pat. No. 5,609,834). A method of coating a combustion catalyst or a steam reforming catalyst on plates is also known (A. L. Dicks, Journal of Power Sources, 61, pp 113-124. 1996).

Haldor-Topsoe reported a heat exchange reformer where a steam reforming catalyst is loaded into a multitubular reactor such that an area for contact with hot combustion gas is increased (A. L. Dicks, Journal of Power Sources, 61 pp 113-124. 1996).

All the above methods make an attempt to increase a heat transfer area by modifying the structure of a reactor and use the existing pellet catalysts. The catalyst pellets filled in the reactor contact each other at their edges or corners so that the contact area between them is very small. Therefore, the heat transfer between the catalyst pellets is performed by convection but not by conduction, so that the heat transfer rate between the catalyst pellets is low. Thus, catalyst pellets far from the heat exchange side have low temperature leading to deterioration in performance.

In an attempt to improve the heat transfer properties of a catalyst by increasing the thermal conductivity of the catalyst itself, there is a method of coating a metal support with a catalyst. A catalyst structure comprising active catalyst metal coated on a monolith (honeycomb) made of a thin metal plate has high thermal conductivity so that the monolith is maintained at a uniform temperature. Also, this catalyst structure has low thermal mass maling rapid heating thereof easy, and is resistant to thermal impact compared to a ceramic monolith catalyst. Methods of using a metal monolith as a support for a catalyst for a partial oxidation reaction are disclosed in U.S. Pat. Nos. 5,648,582 and 6,221,280 B1, but there is no example of a metal monolith being used for steam reformation.

### SUMMARY OF THE INVENTION

The present inventors have conducted a study to solve the problem of low thermal conductivity in pellet catalysts, and consequently, found that if a steam reforming catalyst is used in a form of being coated on a monolith made of a metal having high thermal conductivity, the activity of the catalyst is greatly improved and also that a pressure loss caused by a high flow rate of gas is low, thereby completing the present invention.

Accordingly, it is an object of the present invention to provide a steam reforming catalyst which has high thermal conductivity leading to improved steam reforming performance, and at the same time, low pressure loss even at a high flow rate.

Another object of the present invention is to provide a method of efficiently producing hydrogen using the above steam reforming catalyst.

To achieve the above object, the present invention provides a catalyst structure for steam reformation, in which a nickel-based steam reforming catalyst is applied on a metal monolith.

In the inventive catalyst structure, the metal monolith is preferably a honeycomb made of a metal having excellent durability at high temperature, and has a cell density of 50-2,000 cells/in².

Also, the nickel-based steam reforming catalyst preferably contains nickel, alumina and basic solids.

Moreover, the applied amount of the nickel-based steam reforming catalyst is preferably 0.01-0.4 g per cc of the metal monolith.

In another aspect, the present invention provides a method of producing hydrogen using a steam reforming reaction, the method comprising bringing a mixed gas of hydrocarbon and steam into contact with the above catalyst structure. Reactors usable in this method include a shell-and-tube heat exchanger.

In the inventive hydrogen production method, the space velocity of the mixed gas of hydrogen and steam in the steam reforming reaction is preferably in the range of 1,000-50,000 hr⁻¹.

Also, in the inventive method, the molar ratio of steam to hydrogen is 1-5 moles of the steam per mole of carbon of the hydrocarbon.

In addition, in the inventive method, the hydrocarbon is preferably selected from the group consisting of methane, neutral gas, liquefied petroleum gas (PG), naphtha, volatile oil, and diesel oil.

### BRIEF DESCRIPTION OF THE DRAWINGS

FIG. 1 is a graphic diagram showing the comparison of steam reforming performance between a nickel catalyst applied on a metal monolith and a pellet-type nickel catalyst.

FIG. 2 shows the structure of a heat exchanger reactor for steam reformation.

### DETAILED DESCRIPTION

Hereinafter, the present invention will be described in more detail.

The inventive catalyst for use in a compact steam reformer is in a form where a nickel-based steam reforming catalyst is applied on a monolith made of a metal having high thermal conductivity. The present inventors have found that a catalyst structure where a steam reforming catalyst containing nickel, alumina and basic solids is applied on a honeycomb monolith made of a metal having excellent durability at high temperature shows a higher steam reforming activity than the same volume of a pellet-type or powder catalyst. The applied amount of the nickel-based steam reforming catalyst may be 0.01-0.4 g per cc of the metal monolith, but a preferred application amount is 0.1-0.3 g, because at less than 0.1 g, a clear increase in the activity of the catalyst structure will not be obtained, and at more than 0.3 g, the passages of the honeycomb can be clogged with the coated catalyst.

Also, in the present invention, the cell density of the honeycomb metal monolith is 50-2,000 cells/in², and preferably 100-1,000 cells/in².

Furthermore, in the present invention, the material of the honeycomb metal monolith is not specifically limited, and its examples include metals having excellent durability at high temperature, such as iron, stainless steel, and an iron-chromium-aluminum alloy (Fecralloy).

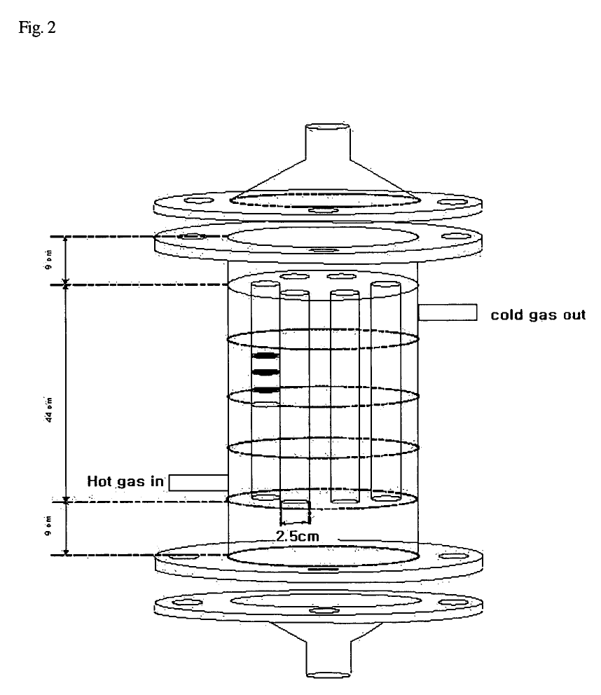

As a reactor in the present invention, a shell-and-tube heat exchange reactor as shown in FIG. 2 can be used, which provides improvements in the heat transfer properties of the metal monolith catalyst structure coated with the nickel-based steam reforming catalyst. When the cylindrical metal monolith catalyst structure is filled in the tube section and hot gas flows through the shell section, the heat transfer through the tube walls to the metal monolith will smoothly progress to promote the supply of reaction heat. An increase in the capacity of the reactor becomes possible by increases in the number and length of the tubes.

As the nickel-based steam reforming catalyst in the present invention, any catalyst which has been generally used in hydrogen reforming reactions in the prior art may be used, and more particularly, a catalyst containing nickel, alumina, magnesium oxide and potassium compounds can be used. This nickel-based steam reforming catalyst is finely powdered and added to water so as to prepare slurry, and the metal monolith is immersed in the slurry to make the inventive catalyst structure.

The inventive method for producing hydrogen is preferably performed by introducing steam and hydrocarbon, such as methane, neutral gas, liquefied petroleum gas (LPG), naphtha, volatile oil or diesel oil, into a shell-and-tube heat exchange reactor filled with the catalyst structure and bringing hydrocarbons and steam into contact with the catalyst. Hot gas flows to the shell section of the heat exchange reactor so as to supply reaction heat. In the steam reforming reaction of hydrocarbon, the reaction temperature is preferably 600-850° C., and the reaction pressure is preferably less than 50 atm. The molar ratio of steam to hydrocarbon is in a range of 1-5 moles of steam per mole of carbon of the hydrocarbon. The space velocity of a mixed gas of hydrocarbon and steam is preferably 1000-50,000 hr⁻¹. If necessary, hydrogen, carbon dioxide gas, nitrogen gas and the like may also be added for the reaction.

In the hydrogen production reaction according to the present invention, there are limitations on the scale of equipment.

Hereinafter, the construction and effect of the present invention will be described in detail using an example, a comparative example, and a test example for the activity of catalysts, but these examples are not construed to limit the scope of the present invention.

1) Preparation of Catalysts

### EXAMPLE 1

The inventive catalyst is in a form where a washcoat of nickel-based catalyst is applied on the wall side of a metal monolith. The metal monolith used in this Example was prepared using an iron-chrornium-aluminum alloy (Fecralloy) plate, and the density of cells in the metal monolith was 640 cells/in². The prepared metal monolith was preoxidized so as to increase the adhesion between a ceramic-based washcoat material and a metal-based monolith. A catalyst (containing 10% nickel and the balance of alumina and other alkaline compounds) used in a commercial steam reforming process was finely powdered and mixed with water to prepare slurry. To the slurry, a suitable amount of nitric acid was added. The metal monolith was coated by immersion in the slurry, and then sintered at 900° C., thus preparing a metal monolith catalyst having a washcoat with the nickel-based catalyst applied thereto. The washcoat amount of the catalyst prepared in this Example was 0.22 g per cc of the monolith.

### COMPARATIVE EXAMPLE 1

For comparison with the catalyst applied on the metal monolith prepared in Example 1, a nickel-based pellet catalyst used in a commercial steam reforming process was crushed, and sieved through a sieve of 4-10 mesh to obtains catalyst pellets with an average diameter of 3 mm. The obtained pellet-type catalyst was used for comparison with the catalyst of Example 1.

2) Activity Test

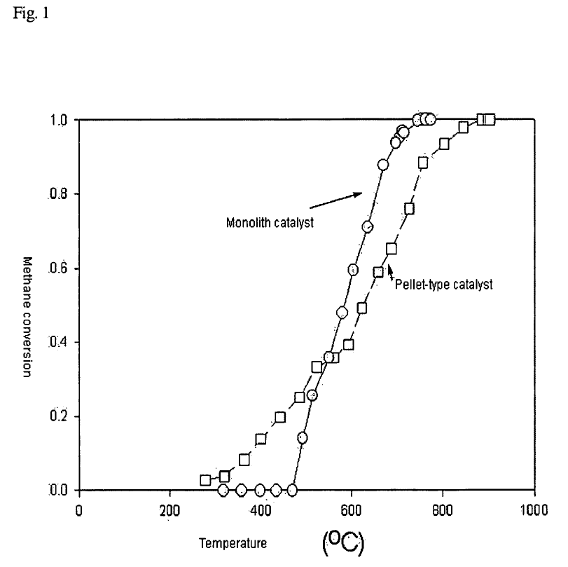

Two metal monolith catalysts (each containing 3.2 g of a nickel-based catalyst) having a diameter of 2.1 cm and a height of 2 cm, prepared according to the method of Example 1, were loaded in a quartz reactor having an inner diameter of 2.1 cm, and a methane steam reforming reaction was performed in the reactor. The temperature of the catalysts was measured with a thermocouple mounted on the lower end of the catalysts. In the methane steam reforming reaction test, the space velocity of reaction gas was 9,000 hr⁻¹ and was obtained by dividing the flow rate of reaction gas at 20° C. and atmospheric pressure by the volume of the catalyst. The reaction gas used in the reaction was a mixed gas of methane and steam, in which the ratio of steam to methane was 3. The reactor was heated by an external heating furnace while analyzing the methane steam reforming performance of the catalysts. The results are shown in FIG. 1.

The nickel-based steam reforming catalyst pellets having an average diameter of 3 mm, prepared in Comparative Example 1, were loaded in a reactor having an inner diameter of 2.1 cm, to a height of 4 cm, and a methane steam reforming reaction was performed in the reactor at a space velocity of 9,000 hr⁻¹. The results are shown in FIG. 1. Similarly to the case of the inventive catalysts, a mixture of methane and steam was used in the reaction, and the ratio of steam to methane was 3.

13.8 cc of the nickel-based catalyst applied on the metal monolith, prepared as in Example 1, and 13.8 cc of nickel-based steam reforming catalyst pellets, having an average diameter of 3 mm, prepared as in Comparative Example 1, were loaded in the respective quartz reactors having an inner diameter of 2.1 cm, and the activity of the catalyst filled in each of the reactors was tested at varying space velocities of 9,440 to 56270 hr⁻¹. The test results are shown in Table 1 below.

Methane conversion shown in FIG. 1 and Table 1 is defined as follows:
Methane conversion=(1-methane flow rate at reactor outlet/methane flow rate at methane inlet)×100

TABLE 1

| | |
|---|---|
| Example 1 | Comparative Example 1 |

| Space | | Catalyst | | Catalyst |
|---|---|---|---|---|
| velocity | Methane | temperature | Methane | temperature |
| (hr⁻¹) | conversion (%) | (° C.) | conversion (%) | (° C.) |
| 9,440 | 99.0 | 731 | 97.9 | 783 |
| 19,000 | 96.4 | 731 | 97.0 | 886 |
| 28,300 | 93.5 | 730 | 84.4 | 859 |
| 38,000 | 83.0 | 690 | 75.7 | 854 |
| 56,270 | 67.0 | 659 | 62.4 | 849 |

As can be seen from the test results for the activities of the catalyst of Example 1 and the catalyst of Comparative Example 1, the nickel-based catalyst coated on the metal monolith shows excellent activity due to its excellent heat transfer properties compared to those of the pellet catalyst, even if its weight is lower than that of the pellet-type catalyst.

Also, the inventive method for producing hydrogen uses the inventive catalyst, thus making it possible to effectively produce hydrogen using a compact production system.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A catalyst structure for steam reformation, in which a nickel-based steam reforming catalyst is applied on a metal monolith.

2. The catalyst structure of claim 1, wherein the metal monolith is a honeycomb made of a metal having durability at high temperature, and has a cell density of 50-1,000 cells/in².

3. The catalyst structure of claim 1, wherein the nickel-based steam reforming catalyst contains nickel, alumina and basic solids.

4. The catalyst structure of claim 1, wherein the applied amount of the nickel-based steam reforming catalyst is 0.01-0.4 g per cc of the metal monolith.

5. A method for producing hydrogen by steam reforming reaction, the method comprising bringing a mixed gas of hydrocarbon and steam into contact with the catalyst structure as set forth in claim 1.

6. The method of claim 5, wherein the mixed gas of hydrocarbon and steam has a space velocity of 1,000-50,000 hr⁻¹.

7. The method of claim 5, wherein a molar ratio of the steam to the hydrocarbon is 1-5 moles of steam per mole of carbon of the hydrocarbon.

8. The method of claim 5, wherein the hydrocarbon is selected from the group consisting of methane, neutral gas, liquefied petroleum gas (LPG), naphtha, volatile oil, and diesel oil.

9. A method for producing hydrogen by steam reforming reaction, the method comprising bringing a mixed gas of hydrocarbon and steam into contact with the catalyst structure as set forth in claim 2.

10. A method for producing hydrogen by steam reforming reaction, the method comprising bringing a mixed gas of hydrocarbon and steam into contact with the catalyst structure as set forth in claim 3.

11. A method for producing hydrogen by steam reforming reaction, the method comprising bringing a mixed gas of hydrocarbon and steam into contact with the catalyst structure as set forth in claim 4.
